(19) United States
(12) Patent Application Publication
(10) Pub. No.: US 2026/0074599 A1
(43) Pub. Date: Mar. 12, 2026

(54) Superconducting Motor with Rotating Multilayer Insulation

(71) Applicant: Hinetics, Inc., Champaign, IL (US)

(72) Inventors: Samith Sirimanna, Urbana, IL (US); Mark Vermilyea, Schenectady, NY (US); Brian Roland, Jamestown, ND (US); Thanatheepan Balachandran, Savoy, IL (US); Kiruba S. Haran, Champaign, IL (US)

(21) Appl. No.: 19/320,540

(22) Filed: Sep. 5, 2025

Related U.S. Application Data
(60) Provisional application No. 63/692,968, filed on Sep. 10, 2024.

(51) Int. Cl. H02K 55/04; H02K 9/22

(52) U.S. Cl. CPC H02K 55/04; H02K 9/223

(57) ABSTRACT

A lightweight, multilayer cryogenic insulator is formed by successive layers of low-emissivity sheeting and high elastic modulus mesh, the latter which provide thermal separation of the sheets while resisting high hoop stresses.

### CROSS REFERENCE TO RELATED APPLICATION

This application claims the benefit of U.S. provisional application 63/692,968 filed Sep. 10, 2024, and hereby incorporated by reference.

### STATEMENT REGARDING FEDERALLY SPONSORED RESEARCH OR DEVELOPMENT

### BACKGROUND OF THE INVENTION

The present invention relates to high power-to-weight electric machines for aerospace applications and the like, and in particular to a superconducting electric motor having an improved multilayered insulator (MLI) for preserving cryogenic temperatures at high speed.

Electric motors for aerospace applications, for example, for use in aircraft, must provide a high specific power, that is high-power output with light weight. Currently produced wound-field synchronous motors can provide about two kilowatts of power per kilogram of weight with a nominal efficiency of about 90 percent. Recent advances using permanent magnets have achieved specific power in excess of 13 kilowatts per kilogram with efficiencies in excess of 96 percent; however, the fault tolerance of such permanent magnet systems has not been established.

Desirably, the permanent magnets of such electric motors could be replaced with superconducting coils to provide improved efficiency and lighter weight (greater specific power). The substantial demands of cryogenic cooling sufficient to cool such motors, however, present a significant challenge because of the weight, complexity, and bulk of such coolers and the necessary plumbing for fluids used for heat transfer between the motor and the cooler.

US Patent publications US 2022/0302816 and 2024/0014709, assigned to the assignee of the present application and hereby incorporated by reference, describe construction techniques for cryogenic electrical motors employing a spoke system for suspending the superconducting rotor magnets about the shaft while providing low thermal conduction between the shaft and the rotor magnets. This spoke system reduces heat transfer to the superconducting windings, improving cooling efficiency.

### SUMMARY OF THE INVENTION

The present invention provides a multilayer insulation (MLI), further reducing the heat passing to the superconducting coils but by radiative transfer rather than direct conduction. The multilayer insulation is constructed of multiple low-emissivity surfaces separated by a high-tensile modulus mesh, the latter which minimizes thermal conductance between the layers because of its open mesh structure while resisting high hoop stresses experienced in a motor environment.

More specifically, in one embodiment, the present invention provides a superconducting machine having a stator and a rotor, the latter with a central shaft rotatably mounted with respect to the stator to allow the rotor to rotate about a shaft axis with respect to a stator. The rotor includes a set of superconducting windings positioned on the rotor shell and a heatshield surrounding the superconducting windings formed of alternate layers of a low emissivity sheet material and an open mesh material, the open mesh material having an elastic modulus at least 10 times that of the low emissivity sheet material.

It is thus a feature of at least one embodiment of the invention to provide a composite MLI suitable for use with a superconducting motor or generator taking advantages of the low-emissivity thin surfaces provided by materials such as aluminized Mylar and the like, combined with a high-tensile modulus mesh material that both minimizes conduction between the layers and conducts high hoop stresses away from the less resistant sheet material.

The open mesh material may provide first elongate members extending continuously over at least 360° of circumference around the shaft axis over the superconducting windings to be aligned with hoop stress caused by rotation of the superconducting windings about the shaft axis.

It is thus a feature of at least one embodiment of the invention to provide force resistant mesh components aligned with the hoop stress to minimize circumferential elongation and distortion of the MLI caused by hoop stresses, while minimizing material weight and conductive paths between layer.

The first elongate members may be under tension when the rotor is at rest.

It is thus a feature of at least one embodiment of the invention to minimize stretching of the low-emissivity sheet material that might occur if there were initial slack in the first elongate members.

The open mesh material may provide second elongate members extending over the superconducting windings in a direction along the shaft axis and wherein the linear density of first elongate members along the shaft axis is higher than the linear density of second elongated members circumferentially to the shaft axis by at least 20%.

It is thus a feature of at least one embodiment of the invention to provide regular mesh openings that minimize out-of-plane distention of the low-emissivity sheet material while also minimizing the weight and conductivity between the low-emissivity sheet material incurred with the second elongate members by independently controlling linear density of the mesh elements according to a trade-off between weight, hoop stress resistance, and mesh opening size.

The layers may be wrapped in a helix around the superconducting windings and shaft axis.

It is thus a feature of at least one embodiment of the invention to provide a simple fabrication technique that minimizes seams between the materials of the MLI.

These particular objects and advantages may apply to only some embodiments falling within the claims and thus do not define the scope of the invention.

### BRIEF DESCRIPTION OF THE DRAWINGS

FIG. 1 is a simplified exploded view of the principal components of a motor constructed according to the present invention including a stator and a concentrically rotating wound-field rotor within a vacuum envelope showing the MLI around the rotor coils;

FIG. 2 is a cutaway exploded perspective view of layers of the MLI showing low-emissivity sheets separated by high-tensile modulus meshes;

FIG. 3 is an end view of the rotor and an exploded inset showing a wrapping of the MLI around the rotor;

FIG. 4 is an exaggerated exploded view showing the spiral winding of the wrapping of FIG. 3; and

FIG. 5 is a simplified representation of a machine for pre-stressing the mesh elements during manufacture.

### DETAILED DESCRIPTION OF THE PREFERRED EMBODIMENT

### Motor Overview

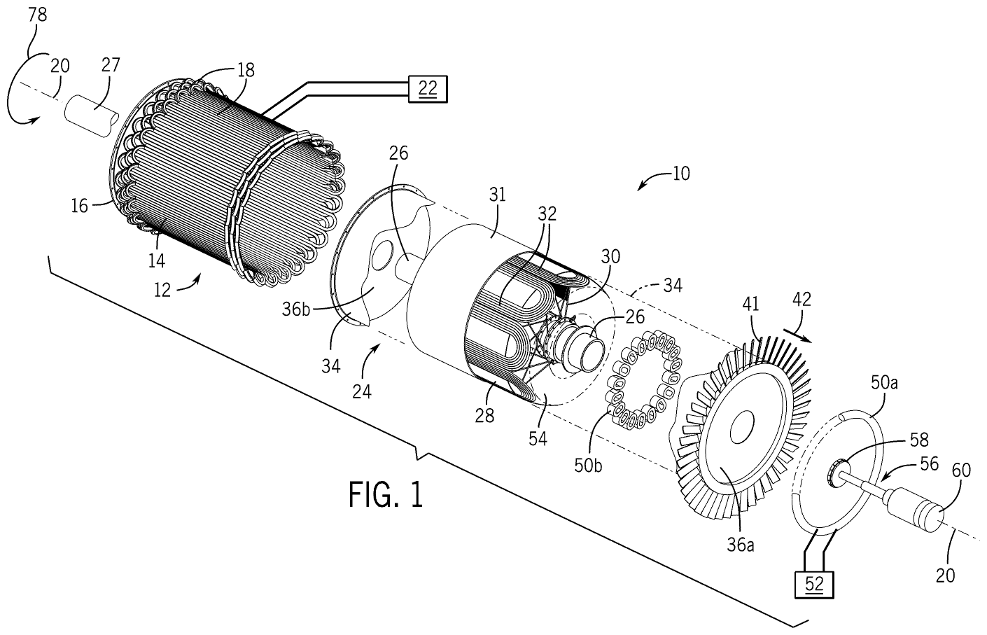

Referring now to FIG. 1, a superconducting motor 10 per the present invention may include a stator 12 providing, in one embodiment, a generally cylindrical, tubular stator form 14 having an outwardly flared end 16. A set of stator coils 18 may be attached to an inner surface of the stator form 14 spaced angularly about an axis 20 of the stator form 14 and extending between its opposite ends to provide a radially directed magnetic axis. The stator coils 18 may be air-core coils stabilized in a potting material as attached to the stator form 14 and may communicate with a motor drive circuit 22, for example, sequentially energizing the stator coils 18 to create a rotating magnetic field about the axis 20 as is generally understood in the art.

Fitting within the stator form 14 to rotate therein about the axis 20 is a rotor 24 providing a tubular rotor shaft 26 that may communicate beyond the confines of the motor 10 as a driveshaft 27 connected, for example, to turbine or propeller systems of aircraft or the like (not shown). The rotor shaft 26 may be supported for rotation on bearings generally understood in the art.

A rotor shell 28 is positioned concentrically around the shaft 26 and held for co-rotation with the shaft 26 by a set of thermally insulated spokes 30 radiating outwardly from the shaft 26. The shell 28 may be constructed of aluminum, or other lightweight material, to have low weight and low moment of inertia and will typically have a radial thickness of less than 100th of the radius of the shell 28 from the axis 20.

An outer surface of the rotor shell 28 includes a set of rotor coils 32 having an elongate racetrack shape and, more specifically, following the shape of a geometric stadium being a rectangle with semicircles at opposite ends, with a longest dimension extending between axial ends of the rotor shell 28. The rotor coils 32 will be spaced circumferentially around the rotor shell 28 and centered within the faces 29 at equal angular intervals and may be air-core planar coils, the latter term, as used herein, meaning that the coils are substantially two-dimensional being wound helically in one or a limited number of layers to conform to a surface. Generally, the rotor coils 32 will be high-temperature superconductive materials so as sustain a strong magnetic field without significant power consumption in the manner of a permanent magnet but with much lower mass and, hence, weight. Generally the rotor coils 32 may be infused with a stabilizing polymer or epoxy material.

As so mounted, the rotor coils 32 may be substantially constrained to a single plane allowing bending of the conductors of the rotor coils but reduced twisting.

The outer surface of the rotor coils 32 may be wrapped with a multilayer insulator 31 as will be described in greater detail below.

Referring still to FIG. 1, a cylindrical vacuum envelope 34 closely surrounds the stator shell 28 and includes end caps 36a and 36b providing bases to the cylinder and sealing the ends of the vacuum envelope 34 against the outer circumference of the shaft 26 to provide an airtight volume 38 that may be evacuated to reduce convective heat loss between the shell 28 and outside structures of the motor and between the shell 28 and the shaft 26. End cap 36b may have a radially outwardly extending impeller 41 pulling air, as indicated by airflow 42, over the outer surface of the stator form 14 for cooling of the same as the rotor 24 rotates.

Positioned on either side of end cap 36a are wireless transmission coils 50a and 50b forming primary and secondary windings of a transformer for transferring power through the vacuum envelope 34 without breach thereof to provide excitation power to the rotor coils 32. Coil 50 may be energized by a high-frequency power source 52, and coil 50b may communicate with the rotor coils 32 by means of a power conditioner 54 providing solid-state rectification and filtering of the alternating current transferred between the transmission coils 50a and 50b to produce the necessary DC voltages for the rotor coils 32. Other systems for wirelessly providing current to the coils 32 include contactless flux pumps of a type known in the art.

Referring still to FIG. 1, in one of multiple embodiments, a cryocooler 56 may extend along the axis 20 and have a cold end 58 passing into the hollow tubular shaft 26 to be roughly centered within the ends of the rotor 24 and attached to the shaft 26 by insulating supports to rotate therewith. A hot end 60 of the cryocooler 56 may extend outside of the vacuum envelope 34 to receive power to drive a sterling cycle heat pump pumping heat from the cold end 58 to the hot end 60 (at ambient temperatures) to bring the temperature of the cold end 58 to cryogenic temperatures of less than 50° Kelvin. Cryocoolers 56 suitable for use with the present invention are commercially available, for example, from the Sunpower Division of AMTEK of Berwyn, Pennsylvania, under the trade name CryoTel GT.

### Multilayer Insulator

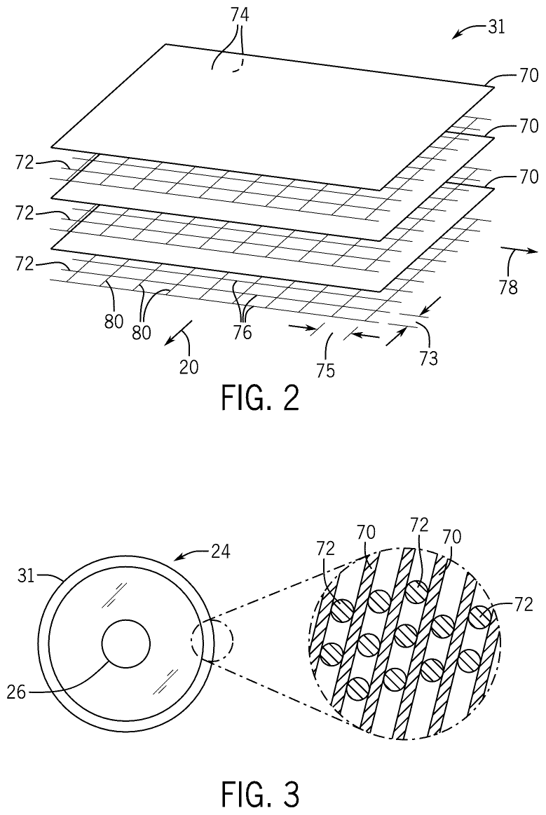

Referring now to FIG. 2, the multilayer insulator (MLI) 31 may comprise alternating layers of a thin low emissivity sheet 70 and an open mesh material 72, the latter providing a thermal barrier between successive low-emissivity sheets 70. The low-emissivity sheet 70, for example, may be a thin polymer material, typically less than 0.005 inches in thickness, and may be metallized, for example, by vacuum metallization on its opposing surfaces 74. The polymer material may be, for example, Kapton™, Mylar™, or Teflon, being trade names for polyimide, biaxially-oriented polyethylene terephthalate, and polytetrafluoroethylene, respectively, or other similar material. This metal may be, for example, aluminum or other low emissivity metal such as gold or the like.

The open mesh material 72 is desirably a set of crossing elongate members, for example, flexible cords or fiber bundles forming a rectangular grid with first members 76 extending in a circumferential direction 78 about the axis 20 to resist hoop stresses from centrifugal force and second members 80 perpendicular to the first members and extending generally axially along axis 20. The mesh material 72 provides openings that comprise at least 5% and, in some cases, at least 10% of the area over which the open mesh material 72 extends. The spacing 73 measured along axis 20 of the first members 76 will generally be closer than the spacing 75 of the second members 80 measured along circumferential direction 78 reflecting the substantial difference in forces that will be resisted by these members 76 and 80. More generally, the linear density of first members 76 along the shaft axis 20 may be higher than the linear density of second members 80 circumferentially to the shaft axis 20 by at least 20% and, in some cases, greater than 40%.

The spacing provided by the interposition of the open mesh material 72 between successive low-emissivity sheets may be of 0.5 mm or less. For this purpose, thickness of the open mesh material 72 measured along a radial direction with respect to the axis 20 will be selected so that under the centrifugal force experienced by the low-emissivity sheet 70 successive layers of the low-emissivity sheet 70 aligned with and separated at the openings of the open mesh material 72 will not touch as they flex under these forces.

The open mesh material 72 and the low-emissivity sheet 70 may be flexible to easily wrap around the rotor 24. The open mesh material 72 will desirably be a material with an elastic modulus of at least 10 and desirably at least 20 times that of the elastic modulus of the low-emissivity sheet 70. More specifically, the open mesh material 72 may have an elastic modulus of at least 50 GPa. Suitable materials include but are not limited to Kevlar™ (para-aramid fibers), glass fiber, and carbon fiber.

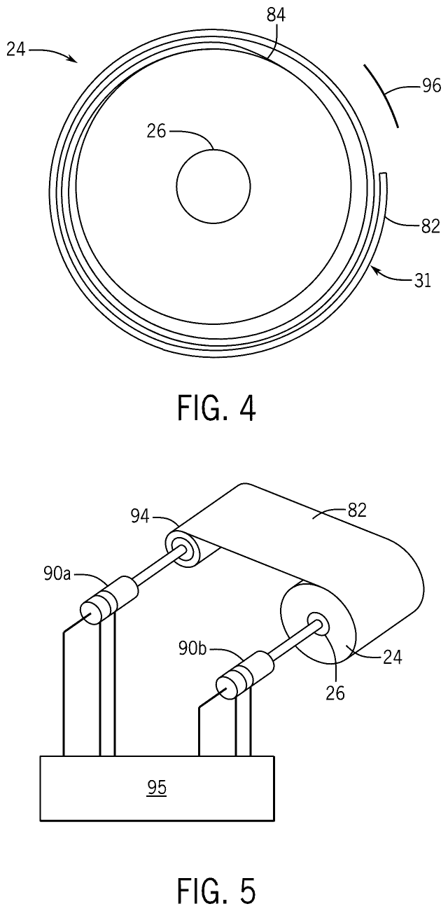

Referring now to FIGS. 3, 4, and 5, a starting edge of a composite layer 82, being a sheet formed by an assembly of one low emissivity sheet 70 on the outside of one sheet of open mesh material 72, may have its open mesh material 72 affixed at a starting line 84 to structure of the rotor 24, for example, by a low thermal conductivity adhesive such as epoxy or the like. The starting line 84 generally extends the full length of the rotor along the axial direction. The composite layer 82 may then be wrapped in a spiral about the rotor 24 and axis 20. During this wrapping process, the low emissivity sheet 70 and open mesh material 72 and successive composite layers 82 will be free to slide with respect to each other to accommodate small differences in radius and hence in the circumferential length. In some embodiments, the low emissivity sheet 70 and open mesh material 72 are free from adhesive material beyond the starting edge to allow relative expansion and contraction under hoop stress and thermal influence without tearing of the low emissivity sheet 70 and to allow the free passage of gas out of the spaces of the open mesh material 72 when the material is placed within the vacuum of the vacuum envelope 34. Alternatively, selective adhesive may be applied between these components that nevertheless retains some air communication through the open mesh material 72.

This approach of winding the composite layer 82 about the rotor 24 naturally accommodates the changes in amount of material necessary to cover the circumference of the rotor 24 as the winding progresses. It will be appreciated, however, that alternatively a set of non-spiral wrappings can be produced with each layer having a constant radius from the axis 20 and successive layers having greater circumference. A total thickness of the layers may be less than 1 cm.

Referring specifically to FIG. 5, when a helical winding is adopted, in this winding process a pair of torque-controlled motors 90a and 90b may connect, respectively, to a spool 94 holding the composite layer 82 and to the rotor 24 by means of its shaft 26. The motors 90a and 90b and may operate to unspool composite layer 82 from the spool 94 to be wrapped around the rotor 24 with a predetermined tension defined by a torque difference between the motors 90a and 90b. This torque difference and the absolute positions of the motor 90b for controlled rotational speed may be under control the motor controller 95 of a type known in the art. The torque-controlled motors 90a and 90b may provide for load cells indicating torque and position encoders so as to provide for regular and controlled winding speed.

During the winding process, as noted above, a first layer of the composite layer 82 may have its open mesh material 72 attached to an outer surface of the rotor 24, for example, by epoxy or the like. Subsequent layers of the composite layer 82, for example, 20-30 layers, may be wrapped in a way to provide gas escape channels and the final end of the composite layer 82 attached to the preceding layer of the composite layer 82, for example, by a termination material 96 being adhesive, tape or the like. This termination material 96 operates to preserve the tensioning of the first members 76 of the open mesh material 72 and makes a positive connection between the open mesh material 72 of the final layer and the open mesh material 72 of the preceding layer, for example, through a small opening in the sheet 70 so that stresses are conducted only through the open mesh material 72 and not limited by intervening material of the sheet 70.

While the above description is generally focused on the construction of a motor, it will be appreciated that the same principles will produce an electrical generator and thus the invention generally involves an electrical machine rather than a motor or generator particularly.

Additional features of the superconducting motor are described in US patent applications: 20220360129; 20220302816; 20240014709; 20230082739; and U.S. Pat. No. 12,068,669, all assigned to the assignee of the present invention and hereby incorporated by reference.

Certain terminology is used herein for purposes of reference only and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A superconducting machine comprising:
a stator; and
a rotor having a central shaft rotatably mounted with respect to the stator to allow the rotor to rotate about a shaft axis with respect to a stator, wherein the rotor includes:
a set of superconducting windings positioned on the rotor shell; and
a heatshield surrounding the superconducting windings formed of alternate layers of a low emissivity sheet material and an open mesh material, the open mesh material having an elastic modulus at least 10 times that of the low-emissivity sheet material.

2. The superconducting machine of claim 1 wherein the open mesh material has an elastic modulus at least 20 times that of the low-emissivity sheet material.

3. The superconducting machine of claim 1 wherein the open mesh material provides first elongate members extending continuously over at least 360° of circumference around the shaft axis over the superconducting windings to be aligned with hoop stress caused by rotation of the superconducting windings about the shaft axis.

4. The superconducting machine of claim 3 wherein the first elongate members are under tension when the rotor is at rest.

5. The superconducting machine of claim 3 wherein the first elongate members have an elastic modulus of at least 50 GPa.

6. The superconducting machine of claim 5 wherein the first elongate members are selected from the group consisting of para-aramid fibers, carbon fiber and glass fiber.

7. The superconducting machine of claim 3 wherein the open mesh material provides second elongate members extending over the superconducting windings in a direction along the shaft axis and wherein a linear density of first elongate members along the shaft axis is higher than a linear density of second elongated members circumferentially to the shaft axis by at least 20%.

8. The superconducting machine of claim 1 wherein the open mesh material is selected from the group consisting of carbon fiber, para-aramid, and fiberglass.

9. The superconducting machine of claim 1 wherein the low emissivity sheet material is a flexible sheet of metallized polymer selected from the group of polyimide, biaxially-oriented polyethylene terephthalate, and polytetrafluoroethylene.

10. The superconducting machine of claim 1 wherein the low-emissivity sheet has a thickness of less than 0.005 inches.

11. The superconducting machine of claim 1 wherein the low-emissivity sheet is aluminized on both of opposite sides of the sheet.

12. The superconducting machine of claim 1 wherein a number of alternate layers is greater than 10.

13. The superconducting machine of claim 1 wherein the layers are wrapped in a helix around the superconducting windings and shaft axis.

14. The superconducting machine of claim 1 wherein the mesh has at least 5% open space.

15. The superconducting machine of claim 1 wherein the total thickness of the layers is less than 1 cm.

16. The superconducting machine of claim 1 wherein the layers are affixed to each other by an adhesive outside of the open areas of the mesh.
